(19) United States
(12) Patent Application Publication
(10) Pub. No.: US 2016/0322645 A1
(43) Pub. Date: Nov. 3, 2016

(54) SINGLE LAYER AIR ELECTRODE AND PROCESSES FOR THE PRODUCTION THEREOF

(71) Applicants: Zhongwei Chen, Waterloo (CA); Dong Un Lee, Etobicoke (CA)

(72) Inventors: Zhongwei Chen, Waterloo (CA); Dong Un Lee, Etobicoke (CA)

(21) Appl. No.: 15/106,222

(22) PCT Filed: Dec. 17, 2014
(86) PCT No.: PCT/CA2014/051230

§ 371 Date: Jun. 17, 2016

Related U.S. Application Data
(60) Provisional application No. 61/963,877, filed on Dec. 17, 2013.

(51) Int. Cl. H01M 4/90; H01M 12/08; H01M 12/06; H01M 4/86; H01M 4/88

(52) U.S. Cl. CPC H01M 4/9016; H01M 4/8615; H01M 4/8828; H01M 4/8896; H01M 12/06; H01M 12/08; H01M 4/8652; H01M 4/8668; H01M 4/8673; H01M 2004/8689

(57) ABSTRACT

A single layer air electrode comprising a porous active catalyst framework. The porous active catalyst framework comprises metallic macroparticles, an active catalyst, a substrate and a binder. The porous active catalyst framework acting as both the active catalyst layer and the gas diffusion layer.

### CROSS REFERENCE TO PRIOR APPLICATIONS

The present application claims priority under Paris Convention to U.S. Application No. 61/963,877, filed Dec. 17, 2013, the entire contents of which are incorporated herein by reference.

### FIELD OF THE INVENTION

The present invention relates to the field of metal air batteries, fuel cells and electrolyzers, and more particularly relates to an air electrode and the production thereof.

### BACKGROUND OF THE INVENTION

Metal-air batteries, metal-air fuel cells, and electrolyzers are highly promising energy conversion and storage systems. In particular, secondary metal-air battery systems demonstrate extremely high theoretical energy density, allowing them to be strong candidates for potentially replacing lithium ion batteries that are currently used in many applications. One area of particular interest for the development of highly efficient metal air battery technologies is the application in electric vehicles (EV) and electric hybrid vehicles (HEV) where low energy capacity of lithium ion batteries currently limits the drivable range. Moreover, metal air battery technologies do not require expensive intercalation material as in lithium ion batteries, and no on-board fuel sources are necessary as the system utilizes oxygen in the ambient air to fuel the vehicles. However, the performances of metal-air battery systems have their own limitations related to electrochemical, chemical, and mechanical stability of the air electrode, especially when in operation for extended periods of time.

A typical conventional air electrode has two or more distinct layers exist, which typically include a gas diffusion layer, and an active catalyst layer. FIG. 1 depicts an example of a conventional multi-layered air electrode (20). FIG. 1 depicts a catalyst layer (22) and a gas diffusion layer (24). Multi-layered air electrodes may further include a hydrophobic layer, and possibly other layers to improve function. In order for the air electrode to function properly, the aforementioned layers must coexist within the electrode and each must effectively play its own role while maintaining high performance as a whole. However, increase in the thickness of the air electrode is generally unfavorable as it increases the internal resistance of the battery, thereby reducing its performance. In addition, each layer in the air electrode is subject to its own weakness, thereby further lowering the overall performance of the energy system. For instance, one of the crucial issues in the current stage of the development of secondary metal-air battery systems is relatively low electrochemical and chemical stability of the air electrode upon extended battery operation, resulting in poor durability of the overall system. One of the key contributors to poor performance in this area is the carbon-based gas diffusion layer that is commonly used in the energy systems. Carbonaceous species are subject to chemical and electrochemical degradation due to contact with highly alkaline electrolyte as well as exposure to high voltages during the battery's recharge cycles. Another issue that must be addressed is the fabrication of the conventional air electrodes, which involves multiple stages that are time consuming and cost inefficient, especially for industrial purposes. One example of such conventional multi-layered air electrodes for metal-air batteries consists of separate air electrode catalyst layer and a gas diffusion layer.¹ The gas diffusion layer is made of porous carbon, which is highly susceptible to degradation and consequently results in loss of active surface area for electrochemical oxygen reactions. Another example of an air electrode according to the prior art is a bifunctional air electrode composed of separate catalyst layer and gas diffusion layer, which is primarily made of carbon with the rest being binding polymer which also contains carbon.² The multilayered air electrode not only introduces resistance associated with battery operation due to interfaces between the layers and the longer diffusion path lengths, but also the carbon and binding polymer can be severely degraded upon repeated charging at high battery potentials. In fact, a recent publication in the literature on degradation characteristics of air electrodes based on carbon has reported significant increases in charge transfer and mass transfer resistances after battery cycling, with 70% reduction in permeability of the used air electrode.³

Kotani et al. describe an air cathode for air metal batteries.⁴ The cathode of Kotani comprises a catalyst layer which contains at least an electrode catalyst and an electoconductive material. Kotani further teaches that the electrode catalyst is an oxide catalyst and that the electroconductive material is at least one kind of metal carbide, such as tungsten carbide or titanium carbide. Brost et al. describe an air electrode and more particularly a catalyst layer for an air electrode comprising a suitable substrate scaffold such as a metal foam or metal fibers, supporting A-site deficient perovskite catalyst particles in contact with the scaffold and a gas permeable or porous ionomer, ionically connecting the particles to a bulk electrode.⁵ Brost further describes the catalytic layer as part of a membrane electrode assembly which includes among other aspects, a gas diffusion layer.

There is a need to develop air electrodes with improved durability particularly under the conditions of use. There is also a need to develop air electrodes that can be produced in an efficient and cost effective manner.

### SUMMARY OF THE INVENTION

In one aspect of the invention there is provided an air electrode comprising a porous active catalyst framework comprising metallic macroparticles and active catalyst.

In a further aspect of the invention there is provided an air electrode comprising a single layer that combines the gas diffusion layer and active catalyst layer.

In a further embodiment the air electrode comprises a substrate which on which the porous active catalyst is cast.

In yet a further embodiment of the air electrode the porous active catalyst framework further comprises a binding material.

In a particular embodiment there is provided an air electrode comprising an active catalyst, metallic macroparticles, a substrate and a binder formed as a single layer.

In a particular aspect the metallic macroparticles are metal powders such as nickel powder, cobalt powder, titanium powder and the like.

In a further aspect of the invention there is provided a process for preparing an air electrode comprising the steps of:

mixing metallic macroparticles with an active catalyst and a binder;

casting the mixture of metallic macroparticles and active catalyst on a substrate; and

pressing the mixture into the substrate.

In a further aspect of the invention there is provided a use of an air electrode as described above in a primary metal air battery, a secondary metal air battery, a metal air fuel cell or electrolyzer.

In a further aspect of the invention there is provided a metal air battery comprising the air electrode as described above.

In a further aspect of the invention there is provided a metal air fuel cell comprising the air electrode as described above.

In a further aspect of the invention there is provided an electrolyzer comprising the air electrode as described above.

### BRIEF DESCRIPTION OF THE DRAWINGS

FIG. 1 is a diagram of a conventional multi-layered air electrode according to the prior art;

FIG. 2A is a diagram of an embodiment of a single layered air electrode; FIG. 2B is an enlarged section of FIG. 2A;

FIGS. 3A and 3B are scanning electron microscopy images (SEMs) of a single layered air electrode;

FIG. 4 is a graph depicting galvanodynamic charge/discharge profiles of conventional air electrode and of a single layered air electrode in a secondary metal air battery;

FIG. 5 is a graph depicting galvanostatic cycling performance of a single layered air electrode in a secondary metal air battery.

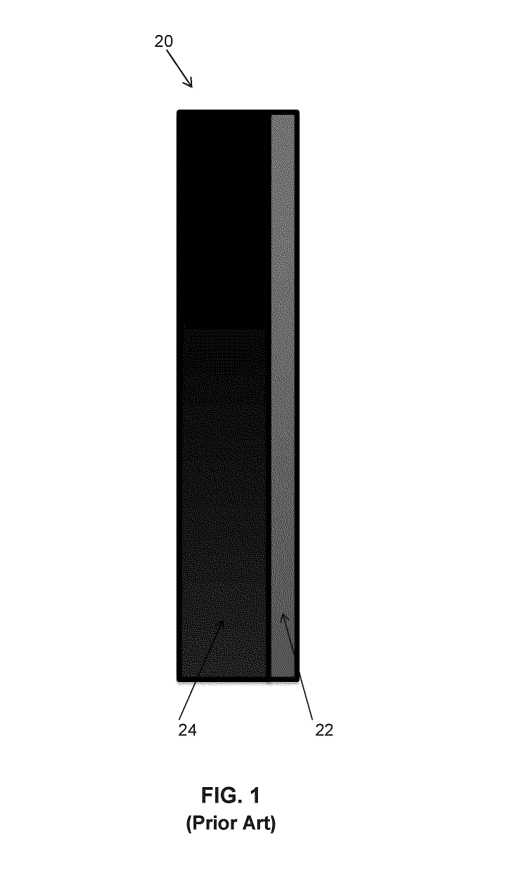

### DETAILED DESCRIPTION OF THE INVENTION

Embodiments of the invention will now be described with reference to the figures.

In an embodiment there is provided an air electrode wherein the gas diffusion layer and active catalyst layer are combined in a single layer. In a particular embodiment, the active catalyst is dispersed within a porous framework to form a porous active catalyst framework. The frame work is sufficiently porous to allow for diffusion of air so that oxygen may react with the catalyst.

In a further embodiment the active catalyst is dispersed within the porous framework such that the entire air electrode is catalytically active.

In a further embodiment the porous framework of the air electrode is formed from metallic macroparticles. The metallic macroparticle framework is sufficiently porous to allow for efficient diffusion of air. The metallic macroparticles may include a variety of different materials. Examples of suitable metallic macroparticles include nickel powder, cobalt powder, titanium powder, silver powder and other metal powders.

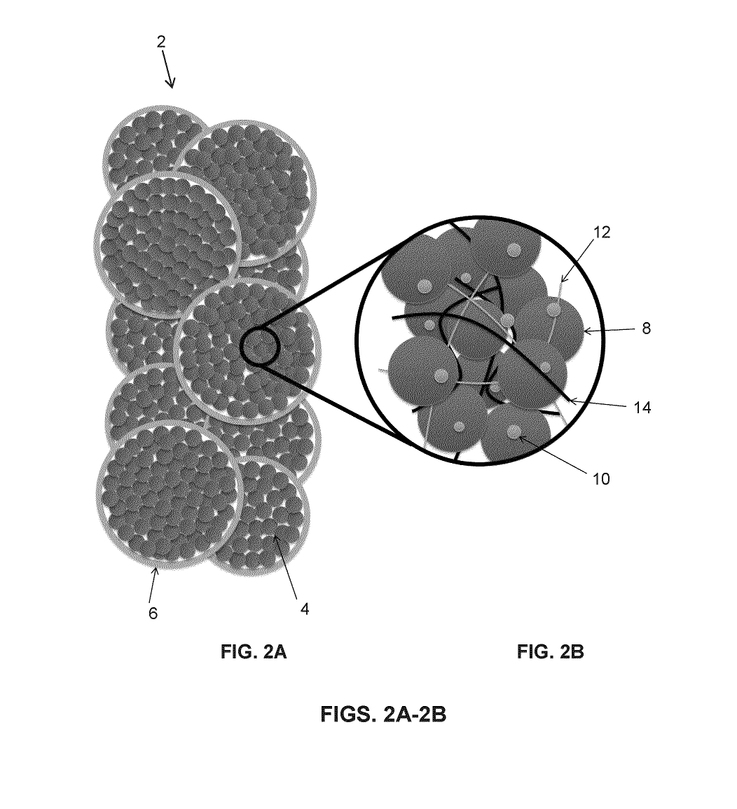

FIG. 2 depicts an example of a single layer air electrode (2) having a porous active catalyst framework (4) and metal porous substrate (6). FIG. 2b depicts an enlarged section of the single layered air electrode of FIG. 2A including porous metal frame work (8), active catalyst (10), held together with binding material (12) and optionally including additives (14).

The air electrode comprises an active catalyst that is able to catalyze the oxygen reactions, oxygen reduction reaction and oxygen evolution reaction. Examples of suitable catalysts include spinel lattice catalysts such as cobalt oxide, manganese oxide, iron oxide, or nickel oxide, mixed transition metal cobalt oxides such as nickel cobalt oxide, manganese cobalt oxide and the like, and persovskite catalysts such as lanthanum nickel oxide and the like. In addition, hybrid catalysts may also be used including hybrids of the aforementioned spinel and/or perovskite catalysts with carbon-based catalysts such as nitrogen-doped graphene, nitrogen doped carbon nanotubes, active carbon and the like. The above identified catalysts are examples of suitable catalysts, however, other catalysts known to those of skill in the may also be used.

In another embodiment the air electrode further comprises a substrate on which the active material is cast. The substrate can be any porous material with pore sizes larger than the size of the metallic macroparticles, as long as the substrate is able to the hold the macroparticles within its porous networks. Examples of such substrates include nickel foam, zinc foam, copper foam, stainless steel mesh, nickel mesh and the like.

In another embodiment, the advanced electrode may further comprise binding material which binds the components of the active catalyst material in the advanced air electrode. Examples of binding material include but are not limited to polymer based materials such as polytetrafluoroethylene, polyvinylidene fluoride, Nafion, and the like.

In another embodiment, the advanced electrode may further comprise additives. The additives may improve the electrochemical and chemical stability, and physical, mechanical, and electrical properties of the advanced air electrode. Examples of the additives include but are not limited to carbon-based materials such as carbon black, carbon nanotubes, carbon nanofibers, graphite, graphene sheets, and the like.

In another aspect, the air electrode is fabricated by a facile procedure, by casting and pressing of the active catalyst material mixture into a substrate. The preparation involves physical mixing of various components of the active catalyst material mixture such as the catalyst, metallic macroparticles and binder. Mixing may be done by various methods including ultrasonication, stirring, and/or grinding or combinations thereof. The casting of the active catalyst material mixture may include one or more of physical deposition techniques such as drop-casting, spin-coating, dip-coating, spray-coating, vacuum filtration, doctor-blade method, or combinations thereof. The pressing of the active catalyst material mixture onto a substrate may include techniques such as hydraulic pressing, hot pressing, roll pressing, or the like or combinations thereof. A person of skill in the art may substitute other known methods of mixing, deposition or pressing into the process for fabricating the air electrode.

In another aspect, the overall thickness of the advanced air electrode can be easily controlled by either the thickness of the substrate or by the degree of pressing during electrode fabrication or both. For instance, electrode fabrication using a relatively thin substrate will result in the advanced air electrode with reduced overall thickness. Pressing with increased pressure during the electrode fabrication will also result in an air electrode with reduced overall thickness. The preferred thickness for the electrode depends on the application. For example, for rechargeable zinc-air battery, a relatively thin air electrode is preferred. For example, a thickness of 150-250 μm is preferred for optimum performance in this system, but a thicker electrode will still work. Electrodes may be designed and scaled with specifications to suit the application for which they will be used.

The air electrodes as described herein can be used in primary or secondary metal air batteries, fuel cells, metal air fuel cells and electrolyzers.

It has been found that the metallic macroparticles of the single layer electrode create a porous framework that allows for efficient air diffusion, allowing the oxygen in the air to easily reach the active catalyst. The single layer electrode eliminates interfaces between catalyst layer and gas diffusion layer thereby reducing resistance associated with the battery operation. The single layer construction not only reduces the diffusion path length of the air to the site of catalysis but also reduces the internal resistance of the device. In addition, the use of metallic macroparticles instead of carbon materials to form a porous framework for air diffusion results in the air electrode being less susceptible to carbon degradation and subsequent electrode failure and leakage. This significantly improves the overall durability of devices in which the air electrode is used. The single layer design also simplifies the process for producing the air electrode. This is expected to reduce manufacturing costs during mass production.

### EXAMPLES

### Example 1

### Fabrication of a Single Layer Air Electrode

The procedure for the fabrication of an exemplary single layer air electrode is as follows. Nickel macroparticles, cobalt oxide nanoparticles, carbon nanotubes, and polytetrafluoroethylene in the ratio of 7.5:1:1:0.5 are physically ground and mixed using mortar and pestle for 10 minutes. Typically, the total mass of the aforementioned materials is 200 mg for the fabrication of an electrode with an area of 6.25 cm2. Next, 3 mL of isopropanol is added to the mixture then it is further mixed by ultrasonication for 2 hours. The mixture is then allowed to evaporate while mechanically stirring until a viscous slurry is obtained. The slurry is then pasted onto a piece of nickel foam, which is then hydraulic pressed for 30 seconds in room temperature. The electrode is finally annealed in air at 300° C. for 30 minutes, and is used to test in a device without further processing.

Corresponding processes may be used to produce single layer air electrodes with different metal macroparticles, catalysts, binders and additives.

### Example 2

### Morphology of the Single Layer Air Electrode

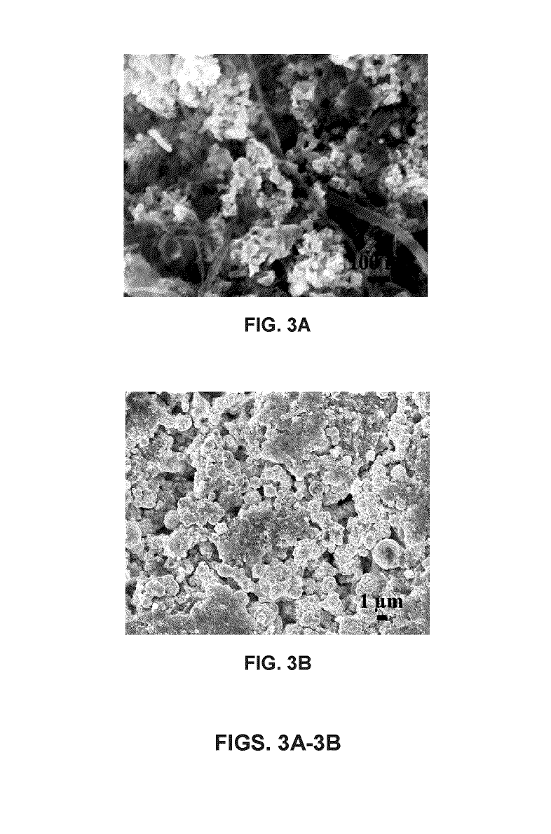

The porous morphology of the single layer air electrode of Example 1 has been revealed by scanning electron microscopy (SEM). The electrode after fabrication has been used for this analysis without any further processing. The electron voltage of 10 keV, working distance of 8.9 mm, and aperture size of 30 μm have been used for SEM imaging. Typical SEM image of the single layer air electrode is as shown in FIGS. 3a and 3b.

### Example 3

### Galvanodynamic and Galvanostatic Performance of the Air Electrode

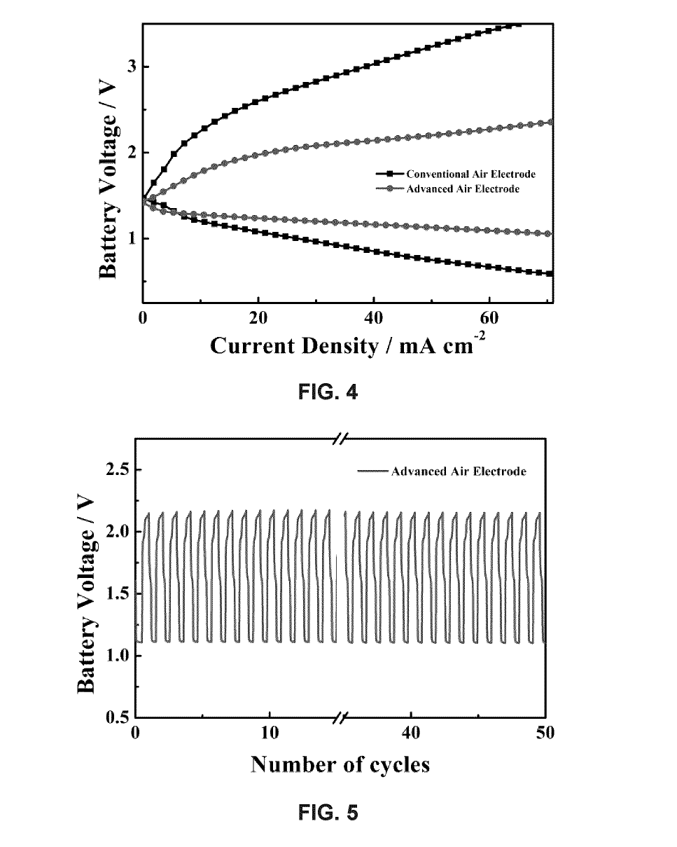

Both galvanodynamic and galvanostatic results are obtained by directly using the single layer air electrode of Example 1 in a prototype rechargeable zinc-air battery. A polished zinc plate is used as the anode, 6.0 M potassium hydroxide with 0.2 M zinc acetate solution is used as the electrolyte, and microporous polypropylene membrane is used as the separator. The following are specific procedures used to obtain data for FIGS. 4 and 5.

### Galvanodynamic Charge/Discharge

The charge/discharge polarization curves shown in FIG. 4 are obtained by applying/draining current ranging from 0 to 70 mA/cm2 with a current step of 5 mA/s.

### Galvanostatic Cycling

The cycling data shown in FIG. 5 is obtained by using a recurrent galvanic pulse method where a fixed current of 50 mA is applied/drawn with each cycling being 10 minutes (5 minute discharge followed by 5 minute charge).

Although the invention has been described with reference to certain specific embodiments, various modifications thereof will be apparent to those skilled in the art. Any examples provided herein are included solely for the purpose of illustrating the invention and are not intended to limit the invention in any way. Any drawings provided herein are solely for the purpose of illustrating various aspects of the invention and are not intended to be drawn to scale or to limit the invention in any way. The scope of the claims appended hereto should not be limited by the preferred embodiments set forth in the above description, but should be given the broadest interpretation consistent with the present specification as a whole. The disclosures of all prior art recited herein are incorporated herein by reference in their entirety.

### REFERENCES

1. Ogumi, Z., et al., Air electrode for metal-air battery, membrane/air electrode assembly for a metal-air battery having such air electrode, and metal-air battery. 2013, US Patent Application No. 2013273442

2. Burchardt, T., Bifunctional air electrode. 2007, US Patent Application No. 2007016602.

3. Ma, Z., et al., Degradation characteristics of air cathode in zinc air fuel cells. Journal of Power Sources, 2015. 274(0): p. 56-64.

4. Kotani et al. US Patent Publication Number 2014/0106240; published Apr. 17, 2014.

5. Brost et al. U.S. Pat. No. 8,728,671; date of patent May 20, 2014.

1. An air electrode comprising a porous active catalyst framework wherein the porous active catalyst framework comprises metallic macroparticles, and active catalyst, a substrate and a binder.

2. The air electrode according to claim 1 wherein electrode is a single layered electrode.

3. An air electrode comprising an active catalyst, metallic macroparticles, a substrate and a binder formed as a single layer.

4. The air electrode according to claim 1 wherein the metallic macroparticles are metal powders such as nickel powder, cobalt powder, titanium powder and the like.

5. The air electrode according to claim 1 wherein the active catalyst is spinel lattice catalyst such as cobalt oxide; a mixed transition metal cobalt oxide such as nickel cobalt oxide or manganese cobalt oxide; a perovskite lattice catalyst such as lanthanum nickel oxide, a hybrid catalysts such as a hybrid of a spinel lattice catalyst and/or perovskite catalyst with carbon-based catalyst such as nitrogen-doped graphene, nitrogen-doped carbon nanotubes or active carbon.

6. The air electrode according to claim 1 wherein the substrate is nickel foam, zinc foam, copper foam, stainless steel mesh or nickel mesh.

7. The air electrode according to claim 1 wherein the binder is a polymer based material such as polytetrafluoroethylene, polyvinylidene fluoride or Nafion.

8. The air electrode according to claim 1 further comprising an additive

9. The air electrode according to claim 8 wherein the additive is a carbon-based materials such as carbon black, carbon nanotubes, carbon nanofibers, graphite or graphene sheets.

10. The air electrode according to claim 1 wherein the electrode is able to undergo oxygen reduction reaction and oxygen evolution reaction.

11. The air electrode according to claim 1, wherein said substrate acts as a current collector.

12. The air electrode according to claim 1 wherein the catalyst material is electrochemically and chemically stable in alkaline electrolytes and at the work potential range of the energy device.

13. The air electrode according to claim 1 wherein the air electrode is bi-functional and may be charged and discharged for use in secondary metal air batteries.

14. A process for preparing an air electrode according to claim 1 comprising the steps of:
mixing metallic macroparticles with an active catalyst and a binder;
casting the mixture of metallic macroparticles and active catalyst onto a substrate; and pressing the mixture into the substrate.

15. The process according to claim 14 wherein the casting is by a physical deposition technique such as drop-casting, spin-coating, dip-coating, spray-coating, vacuum filtration or doctor-blade method.

16. The process according to claim 14 wherein the pressing is by hydraulic pressing, hot pressing or roll pressing.

17. A use of the air electrode as defined in claim 1 as an air electrode in a primary metal air battery, a secondary metal air battery, a fuel cell, a metal air fuel cell or electrolyzer.

18. A metal air battery comprising an air electrode as defined in claim 1.

19. A metal air fuel cell comprising an air electrode as defined in claim 1.
